(19) United States
(12) Patent Application Publication
(10) Pub. No.: US 2008/0311254 A1
(43) Pub. Date: Dec. 18, 2008

(54) Extinguisher Food Product and Method of Manufacture

(75) Inventors: Matthew P.d. Brown, Berkeley, CA (US); Adam DeVito, Sausalito, CA (US); Charlotte Albright, Mill Valley, CA (US); Richard James Kaiser, Allentown, PA (US); Francis Gennaro Schiro, Doylestown, PA (US)

Correspondence Address: DLA PIPER US LLP, 2000 UNIVERSITY AVENUE, E. PALO ALTO, CA, 94303-2248, US

(73) Assignee: BIG BANG IDEAS, INC., Emeryville, CA (US)

(21) Appl. No.: 12/147,334

(22) Filed: Jun. 26, 2008

Related U.S. Application Data
(63) Continuation-in-part of application No. 11/656,652, filed on Jan. 23, 2007.
(60) Provisional application No. 60/761,983, filed on Jan. 24, 2006.
(60) Provisional application No. 60/850,616, filed on Oct. 10, 2006.

(51) Int. Cl. A23L 1/00; A23P 1/04

(52) U.S. Cl. 426/89; 426/416

(57) ABSTRACT

An extinguisher food product is provided in which the intensity level of each piece of food product is controlled. The intensity level of each piece may be a sourness level or a spiciness level. The extinguisher food product may be a hard candy, fruit snack or other snack products.

### PRIORITY CLAIMS/RELATED APPLICATIONS

This application claims priority under 35 USC 120 to U.S. patent application Ser. No. 11/656,652, filed on Jan. 23, 2007 entitled “Extinguisher Food Product and Method of Manufacture” which in turn claims the benefits under 35 USC 119(e) and 120 to U.S. Provisional Patent Application Ser. No. 60/761,983, filed on Jan. 24, 2006 entitled “Extinguisher Candy and Method of Manufacture” and to U.S. Provisional Patent Application Ser. No. 60/850,616 filed on Oct. 10, 2006 entitled “Extinguisher Food Product and Method of Manufacture”, all of which are incorporated herein by reference.

### FIELD OF THE INVENTION

The invention relates generally to a food product and its method of manufacture.

### BACKGROUND OF THE INVENTION

There are many food products, such as fruit snacks, spicy treats and sour food products, available on the market today. For example, there are many known sour candies on the market today such as Sour Tarts, Sour Patch Kids and the like. For each of these different food products, the food product has been designed to have a specific amount or level of sourness. However, none of these existing food products have a plurality of pieces of food product wherein each piece of food product has a different (increased or decreased) level of taste intensity wherein the taste intensity may be sourness or spiciness. In addition, none of these existing food products including candies have a piece of food product that can reduce the taste intensity of the other pieces of food products. It is desirable to provide a food product that has multiple pieces of food products with different levels of intensity and a piece of food product that can reduce the intensity of the other pieces of the food product.

Conventionally, a sour food product is made by a process in which sugar is cooked and an acid is added at the end of the cooking process or acid is added to the exterior of the food product. The problem with these conventional sour food product is that the mixture of sugar used as a base, heat (to cook the food product) and acid (to make the food product sour) contribute to an inversion of sugar which greatly shortens the shelf life of the food product, such as candy. The inversion of sugar is the conversion of sucrose to glucose and fructose, resulting in the liquefaction of the “sugars” in the food product. This liquefaction of the food product makes it unsuitable for normal distribution because it causes the food product to soften or liquefy within several weeks or months. Sugar inversion is directly proportional to the amount of hydrogen ions present in the food product wherein the inversion of sugar occurs more quickly when more hydrogen ions are present. In a sour food product, as the pH drops (i.e. as the sour level increases) the rate of inversion increases. Furthermore, the heat and humidity in the cooking process and in the ambient environment in which the final product rests can accelerate this inversion process. It is desirable to produce a sour food product that reduces the inversion of sugar so that the sour food product has a longer shelf life.

In addition, it is desirable to create other food products that have high intensity, such as high sourness or spiciness. Thus, it is desirable to have a high intensity food product that has a piece of food product that can reduce the intensity or extinguish the intensity of the food product and a method for manufacturing the extinguisher food product. It is to this end that the present invention is directed.

### BRIEF DESCRIPTION OF THE DRAWINGS

FIG. 1 illustrates an extinguisher food product;

FIG. 2 illustrates an example of an embodiment of the extinguisher food product;

FIGS. 3A and 3B illustrate an example of another embodiment of the extinguisher food product;

FIG. 4 illustrates an example of another embodiment of the extinguisher food product;

FIG. 5 illustrates an example of another embodiment of the extinguisher food product that may be a hard candy; and

FIG. 6 illustrates an embodiment of a method for manufacturing the extinguisher hard candy shown in FIG. 5.

### DETAILED DESCRIPTION OF SEVERAL EMBODIMENTS

The invention is particularly applicable to a sour extinguisher food product with the particular pieces of food product and method of manufacture set forth below and it is in this context that the invention will be described. It will be appreciated, however, that the extinguisher food product in accordance with the invention has greater utility since the extinguisher food product may be made with a different number of pieces of food product (from 1 to hundreds) wherein each different piece of food product has a different intensity level (which may be sourness or spiciness), may be made with different ingredients/components and may be made with different manufacturing techniques and those changes are within the scope of the invention as those changes would be known to one of ordinary skill in the art.

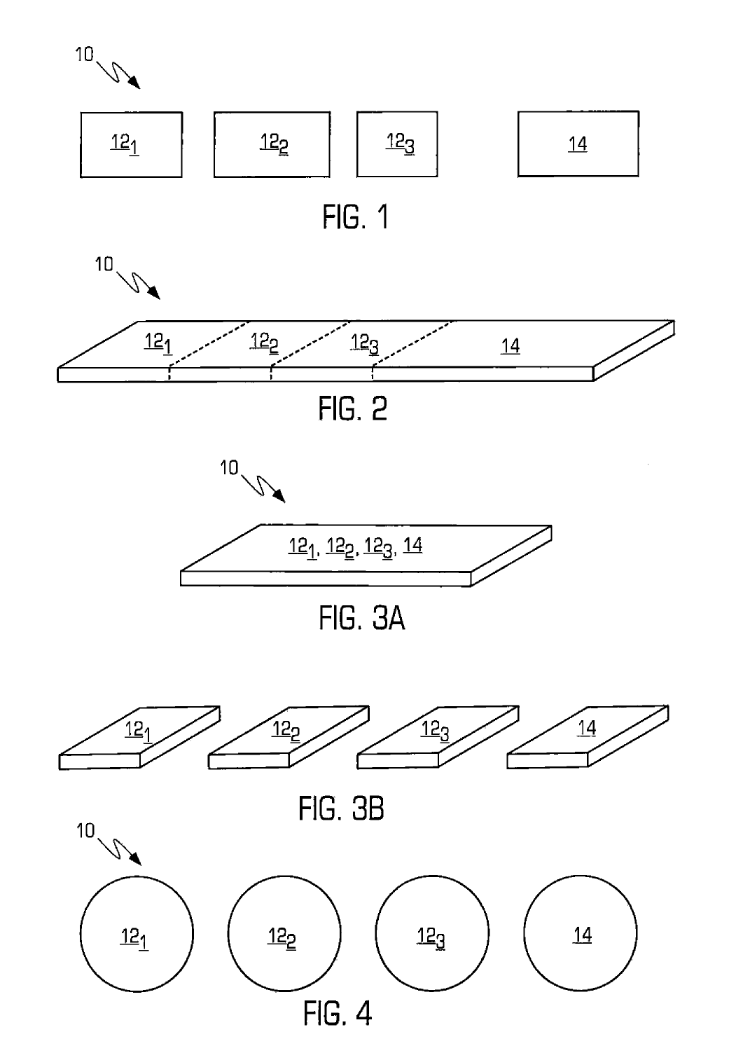

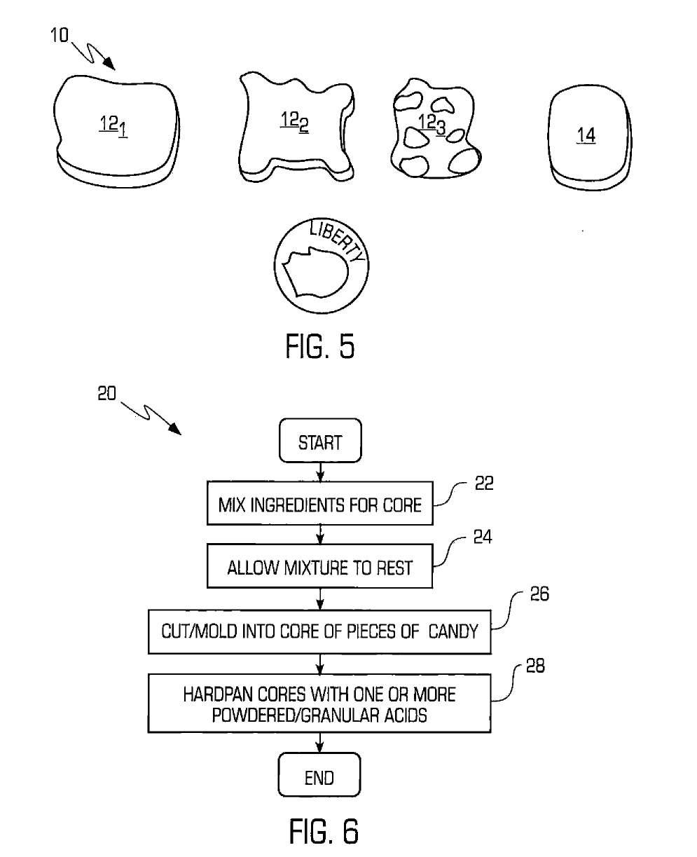

FIG. 1 illustrates an extinguisher food product 10 wherein the food product has one or more pieces 12 (12₁-12₃ shown in the example in FIG. 1) with different intensity levels and an extinguisher piece 14. The different intensity levels may be increasing levels of a characteristics of the food product, such as sourness or spiciness of each piece of the food product. The extinguisher piece 14 may counteract/reduce the effect of the other pieces 12. For example, for a food product with different sourness levels, the extinguisher piece 14 may be a juicy and/or sweet piece that quickly counteracts the effects of the sour pieces. The extinguisher food product may be various different types of food products and some examples of the different types of food products are described below with an exemplary embodiment of the extinguisher food product being a snack or a hard candy as described in more detail below with reference to FIGS. 5 and 6.

The extinguisher food product snack also may be a fruit snack or other snack and can be a chewy snack, such as licorice, a gummy or “chew”/taffy-like texture. The snack may also be one or more pieces of gum. The snack may be fortified in some way and use some amount of real fruit or fruit juice. The snack can be manufactured in various formats. For example, the snack can be made as strips, twisted strips, pieces, a roll or a snack that has a liquid center that is released when the person eating the snack bites into the snack. The intensity levels of the pieces of the snack may be formulated to be contained in each piece, but the components that change the intensity level of each piece of the snack can also be applied to an outer surface of the snack such as by using a coating or a dusting.

FIG. 2 illustrates an example of an embodiment of the extinguisher food product 10 that is a snack. In this example, the snack is a continuous strip of food product (that may be, for example, rolled up when sold to a user) wherein different portions of the strip each have a different intensity level (when that portion of the strip is consumed by the user) as shown in FIG. 2 (with the separations of the different portions illustrated by the dotted lines that are not present in the actual food product) and the strip also has an extinguisher portion 14. Alternatively, the different intensity levels of the portions of the strip can be adjusted by a powder added onto the strip after the strip is manufactured. In one example, the strip may be a fruit snack. FIGS. 3A and 3B illustrate an example of another embodiment of the extinguisher food product 10 wherein the food product is one or more pieces of gum (formed as a single piece as shown in FIG. 3A or formed as separate pieces as shown in FIG. 3B) wherein one or more pieces of gum 12₁-12₃ have one or more intensity levels and there is also an extinguisher piece of gum 14 that has the same characteristics as the extinguisher food product described above. FIG. 4 illustrates an example of another embodiment of the extinguisher food product 10 wherein the food product has one or more pieces that may be, for example, snack pieces. Each piece may have a liquid center/core wherein the liquid center is released when the piece is chewed. The intensity levels of the snack pieces 12₁-12₃ may be due to the components of the snack piece or may be due to the liquid contents. Similarly, there may be an extinguisher piece 14 that counteracts/reduces the intensity level of the other pieces wherein the extinguisher property of this piece is due to the components of the snack piece or may be due to the liquid contents. In one example, the pieces may be fruit pieces. Now, an example of the hard candy embodiment of the extinguisher food product is described in more detail.

FIG. 5 illustrates an example of another embodiment of an extinguisher food product that may be a hard candy. In this example, four pieces of candy 12₁-14 (with pieces 12₁-12₃ having a different level of intensity and piece 14 being the extinguisher piece) are shown for illustration purposes although the extinguisher food product may have a plurality of pieces of candy in a container/packet wherein the plurality of pieces of candy are selected from the four different pieces of candies 12₁-14 shown in FIG. 5. In this example, each piece of candy 12₁-12₃ may have a different sourness level. For example, a first piece 12₁ of candy has a low sourness level, a second piece 12₂ of candy has a medium sourness level and a third piece 12₃ of candy has a high sourness level. For example, each piece of candy may have a different pH level due to the different acid(s) contained in each piece of candy. A fourth piece 14 of candy is the extinguisher piece that counteracts/reduces the effect of the sour pieces of candy. For example, the extinguisher piece 14 may be a juicy and/or sweet candy that quickly counteracts the effects of the sour candies.

In one embodiment, the extinguisher food product may be known as “Sour Extinguisher” candy and may provide a flavorful, interactive and participatory play experience. The market has a need for this play experience using the extinguisher food product and the extinguisher food product fulfills that need. The Sour Extinguisher may include four fruit flavors/colors including three sour fruit flavors of Tangy Tangerine, Super Sour Lemon and Tongue Twisting Lime with increasing levels of sourness. For example, the Super Sour Lemon will be very sour for many children and Tongue Twisting Lime will be extremely sour for the person eating the piece of candy. As children eat the various sour flavors, they can create a variety of sour level experiences. Then, once they have achieved the desired sour level, or reached their maximum tolerance, they can eat a Cool Blue Raspberry extinguisher piece to quickly douse the sourness of the other pieces of candy thereby providing the play experience not available in the market. As shown in FIG. 5, in one embodiment, the sour pieces of candy 12₁-12₃ are bumpy while the extinguisher piece 14 is smoother. The dime shown in FIG. 5 illustrates the size of the pieces of candy shown in FIG. 5 although the invention is not limited to any particular size for each piece of candy or food product.

The “Challenge” for the play experience using the extinguisher food product is to see if the eater can “make it through” all of the sour levels (three in the exemplary embodiment). Then, the extinguisher candy can be eaten by the child who either can't “make it through” all of the sour levels (and needs sour relief) or when the child has made it through all of the sour levels and eats the extinguisher candy as a reward. Furthermore, combining the highest sour level pieces of candy (such as by eating more than one piece of candy at the same time) can create an “extreme” sour experience for the ultimate challenge. The extinguisher candy uniquely calls upon a child's competitive instinct with themselves, their peers and/or their parents. The game play experience variations provided by the extinguisher food product/candy may include: 1) can you handle the intensity level of the pieces of food product and then consume the extinguisher piece to reduce the intensity level once the person has reached his taste intensity limit; 2) combine the pieces of candy to create more intense taste levels and then consume the extinguisher piece to reduce the intensity level once the person has reached his taste intensity limit; and 3) a social play experience in which people are each handed a random piece of the different intensity level pieces and then see who can handle the intensity level of the piece being eaten. Now, a method for producing the extinguisher candy will be described in more detail.

FIG. 6 illustrates an embodiment of a method 20 for manufacturing the extinguisher candy shown in FIG. 5. In this manufacturing method for sour candies, a cold blended process (no heat is used to cook the candy) is used to make a chewy candy core which is then coated with a dextrose/glucose syrup and powdered/granular acid mixture using a hard pan process as described below that achieves the high levels of sourness that are present in the extinguisher candy wherein the cold, blended process may be a cold gum factory process. This process, modified as set forth below, and the unique blend of ingredients for the candy create a shelf-stable, very sour candy. In an alternative method, the cores may be cooked while diminishing the risk of inversion. The cold center process is preferable as it likely allows for more acid in the core than a cooked core. However, making a cooked, chewy center and then coating or sealing the center with one or more substances, such as gum Arabic, then panning as described below may also be used to create the extinguisher food product. This sealing of the cooked center will diminish risk of inversion by preventing migration of sugars and acid between the core and the coating.

For both the cold process and the cooked process, the manufacturing process of the extinguisher candy overcomes the problem of reduced shelf life described above for typical sour candies by retarding the sugar inversion. Thus, the manufacturing process results in reducing sugar inversion which in turn results in less hydrolysis and therefore an increase in shelf life over the conventional sour candies.

As shown in FIG. 6, the manufacturing process 20 may include a step 22 of mixing the components/ingredients of the extinguisher candy core. The extinguisher candy core is made from a mixture of sugar, corn syrup, one or more acids and instant granular starches that require little or no heat to gel. In particular, the formulation is a unique blend of instant starches (such as Staley's Mira-Thik 468 and Mira-Thik 603 which are commercially available), one or more acids, corn syrup, maltodextrin, gelatin, and sugar that can be mixed without heat to result in a chewy texture and a sour flavor without concern of the candy going into hydrolysis. The candy is formulated at the finished moisture content thereby eliminating any need for evaporative cooking.

In step 24, the mixed ingredients for the cores of the candy are permitted to rest for a specified period of time (preferably 2-3 hours) prior to being cut or molded into shape which is a novel process step for manufacturing a sour candy. This step allows for the moisture levels to stabilize, thereby, reducing the incidence of cold flow which is the movement of a candy from one shape to another with no external forces (other than gravity) acting thereon. In step 26, once the mixed ingredients have rested, the core of each piece of candy is produced by forming and/or cutting the mixed ingredients into pieces. In one embodiment, each piece of sour candy 12₁-12₃ may be manufactured using the same core (to reduce manufacturing costs), but it is also possible to make each piece of candy 12₁-12₃ with a different core wherein each core for each piece of candy has a different level of sourness by using one or more acids (as described below) for each core. In addition, extinguisher piece may be manufactured using its own core.

In step 28, once the cores of the pieces of candy are made, the cores for the sour pieces may be put through a hard panning process. The hard panning process in conjunction with the one or more acids as described below produce the bumpy pieces of candy as shown in FIG. 5 that have the desired level of sourness. During the hard panning process, the cores are placed into a hard panning unit that agitates the cores while coating them with a mixture of glucose/dextrose and one or more granular/powdered acids wherein the mixture dries and forms a shell over the core that has a desired level of sourness since the one or more granular/powdered acids are trapped into the dried shell. The process of forming the shell over the core may be repeated multiple times (up to 10 times) to create the desired piece of candy. The manufacturing process may also include a step, once the hard panning is completed, of coating each piece of candy with a hard layer over the shell layers to improve the shelf life of the pieces of candy and protect the pieces of candy from moisture. The core for the extinguisher piece is not hard panned, but may be coated with the hard layer to improve the shelf life of the pieces of candy and protect the pieces of candy from moisture.

In order to achieve the desired sourness of the extinguisher candy, one or more acids are used wherein prolonged sourness and/or tartness is achieved because of an overlap of the acid release times. In more detail, a mixture of different types of acids results in a sequential acid release of sourness and tartness that work with the citrus profile of the flavors. The multiple acids provide an extinguisher candy with an optimal taste for a specific period of time. In an exemplary embodiment, the extinguisher candy may use four different acids (including tartaric acid, citric acid, lactic acid and fumaric acid) to create a different sour sensation and intensity level in the mouth. The tartaric acid creates an immediate spike of sour and tartness. Then, as the tartaric acid starts to fade, the citric acid is sharp, astringent and works best with citrus flavors. The lactic acid (milder but lingering) elongates the sour sensation as does the fumaric acid which has a delayed but “clean” tartness. For the Sour Extinguisher example set forth above, the Tangy Tangerine piece contains only the citric acid, the Super Sour Lemon piece contains the citric and fumaric acids (and the fumaric acid in powdered/granular form is used during the hard panning process to coat the core) and the Tongue Twisting Lime piece (the sourest piece) uses citric, fumaric and tartaric acids (and the fumaric and tartaric acids in powdered/granular form are used during the hard panning process to coat the core).

For the exemplary embodiment of the extinguisher candy (the Sour Extinguisher), each piece of sour candy (Tangy Tangerine, Super Sour Lemon and Tongue Twisting Lime) may have the following ingredients (as an approximate percentage of the total ingredients in each piece of candy wherein the total percentage may be slightly more than or less than 100 due to rounding off of the percentages for each ingredient) in the core and in the shell of each piece of candy:

TABLE 1
INGREDIENTS FOR EXEMPLARY SOUR PIECES OF CANDY

| | Percentage By Weight | | | |
|---|---|---|---|---|
| | | | | Tangerine |
| | | Lime Piece | Lemon Piece | Piece |
| Ingredient | Core | Shell | Shell | Shell |
| Sugar | 29 | | | |
| Corn Syrup | 15 | | | |
| Dextrose | 17-23 | | | |
| Modified Food | 4.5 | | | |
| Starch (468) | | | | |
| Modified Food | 8.9 | | | |
| Starch (606) | | | | |
| Maltodextrin | 6 | | | |
| Citric Acid | 4.2-6.7 | | | |
| Potassium Citrate | 1.5 | | | |
| Gelatin | 2.2 | | | |
| Palm Oil | 1.5 | | | |
| Soy Lecithin | 0.2 | | | |
| Flavor | 0.2-0.6 | | | |
| Lactic Acid | | | | |
| Tartaric Acid | | 2.4 | | |
| Fumaric Acid | | 1.8 | 0.8 | |
| Color-Titanium | | 0.1 | 0.1 | 0.1 |
| Dioxide | | | | |
| Yellow 5 | | 0.0144 | 0.075 | |
| Yellow 6 | | | | 0.02 |
| Blue 1 | | .003 | | |

The core of each piece of candy in Table 1 has the same ingredients, but the percentages for each different piece of candy are different since each candy has a different coating (coated onto each piece of candy during the hard panning process) which affects the percentage for each ingredient. In addition, the formulation set forth in Tables 1 and 2 are merely an example of the formulation of each piece of candy and the invention is not limited to the particular formulation set forth in Tables 1 and 2. In this example, the least sour piece of candy has one type of acid, the middle level of sourness piece of candy has two types of acid and the most sour piece of candy has four types of acid which partially accounts for the different levels of sourness for each piece of candy.

The extinguisher piece of candy (Cool Blue Raspberry) may have the following ingredients (again as a percentage of the total ingredients in the piece of candy wherein the total percentage may be slightly more than or less than 100 due to rounding off of the percentages for each ingredient) in the core and in the shell of the extinguisher piece of candy:

TABLE 2
INGREDIENTS FOR EXEMPLARY EXTINGUISHER
PIECE OF CANDY

Percentage by Weight

| Ingredient | Core | Shell |
|---|---|---|
| Sugar | 41 | |
| Corn Syrup | 22.765 | |
| Dextrose | 18 | |
| Modified Food Starch | 6 | |
| (468) | | |
| Maltodextrin | 5.9 | |
| Citric Acid | 0.5 | |
| Potassium Citrate | 0.25 | |
| Gelatin | 1.2 | |
| Palm Oil | 4 | |
| Soy Lecithin | 0.1 | |
| Flavor | 0.1 | |
| Color-Titanium Dioxide | | 0.18 |
| Blue 1 | | .002 |
| Red 40 | | .003 |

As with Table 1, Table 2 shows the ingredients listed as a percentage of the total weight of the extinguisher piece of candy.

In an alternative embodiment of the invention, during the manufacturing process, a first set of mixed ingredients, a second set of mixed ingredients, a third set of mixed ingredients and a fourth set of mixed ingredients may be formed wherein the three different sourness level pieces of candy are produced from the first, second and third set of mixed ingredients, respectively and the extinguisher candy is made from the fourth set of mixed ingredients since each different piece of candy has a slightly different set of ingredients for the core. If an extinguisher candy with a different number of sour pieces of candy or a different extinguisher candy (such as a drink extinguisher), then a different number of sets of mixed ingredients may be generated during the manufacturing process and those different number of sets of mixed ingredients are within the scope of the invention.

In the above manufacturing process, to make the piece of the extinguisher candy extremely sour and prevent sucrose inversion, the process minimizes the exposure of the extinguisher candy to high temperatures (when using the cold process), uses ingredients in dry, powdered or granular form to reduce moisture in the final product, adds buffer salts such as citrates or lactates and hard pans with a very high level/mix of hydrophobic acids. When using a cooked core process, the core is sealed to prevent the sucrose inversion.

In alternative embodiments, the extinguisher candy may also have any number of piece of candy with each piece of candy having a different level of sourness wherein three levels is preferred (as described above), but 2 or more levels of sourness may be used for the extinguisher candy. In another alternative embodiment, the extinguisher candy may use the sour pieces of candy as described above, but have a drink instead of the extinguisher piece of candy. The drink may be juicy and/or sweet drink that reduces the sourness. Alternatively, the extinguisher candy may be one or more sour tablets that dissolve in a glass of liquid to create drinks with different sourness levels and then a sugar tablet that dissolves into the liquid and reduces the sourness of the drink.

The extinguisher candy described above is a candy in which the levels of sourness of the pieces of candy are varied and the extinguisher piece of candy reduces the sourness. The extinguisher candy may also be created wherein each piece has a spicy/hot sensation wherein the pieces of candy have different levels of spiciness/hotness and the extinguisher piece reduces the spiciness/hotness of the pieces of candy. The same “game” as described above for the sour pieces of candy can also be played using these spicy pieces of candy.

In addition to the embodiments described above, the food product may be a single piece with two different features/components/(whatever the right word is) wherein one feature includes sensory property or properties, such as bitter, salt, sour, or heat, and another feature that helps reduce the sensory property(ies). For example, in the case of a spicy hard candy, the outer layer of the spicy hard candy could have sensory property(ies) such as capsaicin that creates a heat sensation in the mouth. After the sucking on the candy, the user may want to reduce the effects, including taste, of the sensory properties. Therefore, biting into the center of the piece that has an “extinguisher” effect would be a benefit. The extinguishing effect is a perceived reduction in the original sensory properties. The extinguisher effect could be accomplished with hard, soft, spray, gel, liquid or other edible textures.

In this embodiment, which is an alternative to the aforementioned embodiment, the food product may have a single piece with two different features in which the one feature is designed to increase in sensory intensity so long as the user continues to interact with it (e.g., suck on it in the mouth) and the other feature has a reducing effect on the sensory intensity. The increase in the intensity or sensory properties may be increased by: 1) designing the sensory portion to have several different layers with different formulae in each layer; or 2) the sensory portion includes an ingredient like menthol that increases in intensity through increased, accumulating exposure to it.

In this proposed embodiment, the single food product piece is constructed so that the extinguisher component is built separately from the intense component and later assembled or affixed to the intense component. Because the two components are separately constructed, each can be formulated and processed to achieve maximum benefit effect and delivery. A number of highly different formulation and physical characteristics for each of the separate components can be achieved in this manner that would not be possible with in-situ processing. Additionally, a number of assembly mechanisms can be employed to create the final physical product design that would not be achievable through in-situ processing.

For example, in this new embodiment the extinguisher can be a separately constructed using an encapsulant such as gelatin, which can be cold formed around the extinguisher material similar as in the way a cough or cold remedy liquid gel capsule is formed. The capsule then can be affixed to the intense candy component. The candy could be made in a ring formation and the extinguisher capsule could be made in a size such that it fits inside the ring and is bonded by heat or sugar/water solution or an edible adhesive. The user could simply bite into the encapsulate to release the extinguisher, which could be in the form of a liquid rather than a gel as might be required by in-situ processing.

An additional example is that the extinguisher could also be the same shape as the intense component and affixed to the candy as previously discussed. The extinguisher “package” can be made of any edible polymer or naturally occurring edible material and contain the extinguisher material. Or, the extinguisher can be made of any shape and affixed to the intense portion. Neither of these approaches would be possible with in-situ processing.

In this embodiment, the food product may also have a two piece solution in which one piece features the sensory effect and the other is the extinguisher piece that when eaten reduces the sensory effects of the first piece. For example, in the embodiment of a two piece food product, a person with a cold may want to have one food piece that provides sensory property(ies) that help sooth symptoms like cough, sinus congestion or sore throat, and then have a separate food piece (which could be hard, soft, spray, gel, etc) that helps reduce the sensory properties. For example, in the case of cough drops, one piece may include sensory properties based on menthol that help reduce clear sinuses. After the symptoms have subsided, the user may want to reduce the effects, including taste, of the menthol. Therefore, eating a second piece that reduces the sensory effects of the menthol would be a benefit.

In this embodiment, which is an alternative to the aforementioned embodiment, the food product may have a two piece solution in which the piece featuring the sensory effect is designed to increase in sensory intensity so long as the user continues to interact with it (e.g., suck on it in the mouth) and the other piece is designed to reduce effect on the sensory intensity. The increase in the intensity or sensory properties may be increased by: 1) designing the sensory piece to have several different layers with different formulae in each layer; or 2) the sensory pieces includes an ingredient like menthol that increases in intensity through increased, accumulating exposure to it.

In this embodiment, the any of the aforementioned food products may also supply a secondary flavor or active ingredient in the extinguisher piece, component or feature. This secondary flavoring would be of sufficient amount that it would detectable by the user. Additionally the flavor could also incorporate a secondary active, sensory ingredient that could provide a benefit such as treating a sore throat or sore mouth. For example, if an ingredient such as a capsaicin were included as the secondary flavor, it would provide an experience, depending on the amount provided, ranging from warming relief to fiery hot.

This would provide the consumer with three sensations: (1) first is the original intense flavor, (2) secondly the reducing of the intensity, and (3) thirdly the next flavor or sensory experience.

While the foregoing has been with reference to a particular embodiment of the invention, it will be appreciated by those skilled in the art that changes in this embodiment may be made without departing from the principles and spirit of the invention, the scope of which is defined by the appended claims.

1. A food product, comprising:
a piece of food product;
the piece of food product comprising a sensory component having a sensory intensity; and a different component being an extinguisher portion that reduces the intensity level of the first portion when consumed after consumption of the outer layer.

2. The food product of claim 1, wherein the sensory intensity increase as long as a user interacts with the sensory portion until the user interacts with the extinguisher portion.

3. The food product of claim 2, wherein the sensory portion further comprises one or more different layers wherein each layer has a different sensory intensity.

4. The food product of claim 2, wherein the outer later further comprises an ingredient that increases in intensity through increased, accumulating exposure to the ingredient.

5. The food product of claim 4, wherein the ingredient providing sensory intensity further comprises menthol.

6. A food product, comprising:
a first piece of food product and a second piece of food product;
the first piece of food product having specific sensory effect; and
the second piece of food product further comprises an extinguisher portion that reduces the sensory effect of the first piece of food product when consumed after consumption of the first piece.

7. The food product of claim 6 wherein the sensory effect increases as long as a user interacts with the first piece of food product until the user interacts with the extinguisher portion.

8. The food product of claim 7, wherein the first piece of food product further comprises one or more different layers wherein each layer has a different sensory effect.

9. The food product of claim 7, wherein the first piece of food product further comprises an ingredient that increases in intensity thru increased, accumulating exposure to the ingredient.

10. The food product of claim 9, wherein the ingredient further comprises menthol.

11. A food product, comprising:
a first piece of food product and a second piece of food product;
the first piece of food product having specific sensory effect; and
the second piece of food product further comprises an extinguisher portion that reduces the sensory effect of the first piece of food product when consumed after consumption of the first piece and a secondary flavoring that provides a sensory experience.

12. The food product of claim 11 wherein the sensory effect increases as long as a user interacts with the first piece of food product until the user interacts with the extinguisher portion.

13. The food product of claim 12, wherein the first piece of food product further comprises one or more different layers wherein each layer has a different sensory effect.

14. The food product of claim 12, wherein the first piece of food product further comprises an ingredient that increases in intensity thru increased, accumulating exposure to the ingredient.

15. The food product of claim 14, wherein the ingredient further comprises menthol.

16. The food product of claim 11, wherein the secondary flavoring further comprises capsaicin.

17. A method for manufacturing a food product, comprising:
forming an extinguisher portion having an extinguisher ingredient that reduces a sensory effect caused by an ingredient;
forming, separately from the extinguisher portion, a first piece having the ingredient that causes a sensory effect; and
combining the extinguisher portion and the first piece to form the food product.

18. The method of claim 17, wherein forming an extinguisher portion further comprises encapsulating the extinguisher ingredient by an encapsulant.

19. The method of claim 18, wherein combining the extinguisher portion and the first piece to form the food product further comprises affixing the encapsulated extinguisher portion to the first piece to form the food product.

20. The method of claim 18, wherein forming the first piece further comprises forming a ring and wherein combining the extinguisher portion and the first piece to form the food product further comprises fitting the extinguisher portion inside of the ring to form the food product.
